(19) United States
(12) Patent Application Publication
(10) Pub. No.: US 2003/0011245 A1
(43) Pub. Date: Jan. 16, 2003

(54) Electric device

(76) Inventor: Arnim Fiebig, Leinfelden-Echterdingen (DE)

Correspondence Address: Striker Striker & Stenby, 103 East Neck Road, Huntington, NY, 11743, US

(21) Appl. No.: 10/204,372

(22) PCT Filed: Feb. 14, 2001
(86) PCT No.: PCT/DE01/00551

(30) Foreign Application Priority Data
Mar. 28, 2000 (DE) 100 15 398.4

(51) Int. Cl. H02J 7/00

(52) U.S. Cl. 307/48; 307/150

(57) ABSTRACT

The invention is based on an electrical device, in particular a power tool, having a connection point (10) to which at least one power supply unit (12) can be coupled.

It is proposed that via an information connection (14) at least from the connection point (10), information can be forward to the power supply unit (12), and the information can be utilized in a unit (16) in the power supply unit (12).

### PRIOR ART

The invention is based on an electrical device as generically defined by the preamble to claim 1.

From U.S. Pat. No. 4,835,410, a power tool is known with a connection point to which a power supply unit and a battery can be coupled. For the sake of supplying current, the connection point has electrical contacts and a closure bracket, by way of which the battery and the power supply unit can be secured to the power tool.

### ADVANTAGES OF THE INVENTION

The invention is based on an electrical device, in particular a power tool, having a connection point to which at least one power supply unit can be coupled.

It is proposed that via an information connection at least from the connection point, information can be forward to the power supply unit, and the information can be utilized in a unit in the power supply unit. Via the information connection, various information that appears useful to one skilled in the art can be forwarded from the power supply unit to the electrical device and in particular from the electrical device to the power supply unit and utilized in corresponding units. Via the information forwarded, certain functions can be monitored, such as whether a desired contact connection between the electrical device and the power supply unit exists or not, and so forth.

Moreover, in particular information from the electrical device can be used for adapting the power supply unit to the electrical device, in particular with regard to the voltage and/or current intensity that is output. The power supply unit can advantageously be used in flexible ways for various electrical devices of the same or different types, and it is possible with certainty to prevent operating certain electrical devices with the wrong voltage and/or current intensity. The information-utilizing unit is advantageously formed by a regulating unit, to which set-point values are forwarded via the information connection.

Additionally via the information connection, information for avoiding an overload on the electrical device can advantageously be forwarded, in particular temperature parameters, from which an overload on the electrical device can be derived quickly, securely and in a structurally simple way. The current can advantageously be limited directly via the power supply unit; there is no need for additional current-limiting units and the associated weight, structural space, and effort and expense of assembly involved.

Physically, the information connection can be achieved in various ways that appear useful to one skilled in the art, such as infrared, radio, and so forth. If the connection point of the electrical device and the power supply unit each have at least one contact point, which is mechanically connectable upon coupling of the power supply unit and by way of which the information can be forwarded, then the information connection can be realized especially economically and simply.

In a further feature of the invention, it is proposed that for a charging operation of a battery, the power supply unit can be operatively connected to a connection point of the battery. Electrical and electronic components in the power supply unit can be used for supplying current to the electrical device and also for a charging operation for a battery. Additional components or an additional charger and their expense can thus be eliminated. The connection point of the power supply unit for the charging operation is advantageously formed by a connection point by way of which the power supply unit can be connected to the electrical device. However, in principle, the power supply unit can also have a second connection point for a charging operation for the battery.

The power supply unit can be embodied as connectable directly or advantageously via an adapter to the battery. By means of an adapter, an advantageous battery charger can be achieved with the power supply unit, and in it, identical connection points on the power supply unit and the battery can easily be connected to one another. Additional connection points and possibly additional information connections can be avoided, and structurally simple, economical embodiments can be achieved. Existing contact points on the power supply unit, by way of which information can be picked up from the electrical device, can be used to adapt the power supply unit to the charging operation accordingly; for instance, a charging current output by the power supply unit can be suitably adapted to the charge state of the battery.

The adapter can be embodied purely as an especially inexpensive adapter plug, or, as proposed in one feature, a regulating unit can be integrated with the adapter, and by way of the regulating unit the charging operation, in particular, can be embodied in a regulatable way, and suitable parameters can be forwarded to the power supply unit. Additional installation space and weight in the power supply unit can advantageously be avoided and shifted to the adapter.

If the adapter has at least two connection points, for charging two batteries simultaneously, the total charging time can be shortened and the service life can be lengthened. Moreover, one adapter can be used for several tools, and additional adapters and expense can be eliminated.

For charging the batteries as flexibly as possible, for instance, in the case of power tools, charging them en route to a construction site and/or on the construction site itself without a mains connection, the adapter is advantageously embodied with a connection point, by way of which the adapter can be supplied with current via a cigarette lighter in a motor vehicle. If the power supply unit is connectable directly to the battery for a charging operation, then a corresponding connection point can also be provided on the power supply unit, an example being a socket into a which a special cord with a suitable plug for a cigarette lighter can be plugged.

It is also proposed that the adapter be integrated with a case of the electrical device. The adapter can be connected to the case via a releasable nonpositive and/or positive connection or advantageously via a non-releasable connection. The adapter can be retained in captive fashion in the case, and if the adapter is embodied at least partly integrally with the case, savings in terms of additional components, installation space, weight and costs can be achieved.

The invention can be employed in various electrical devices that appear appropriate to one skilled in the art, but especially advantageously so in electrical devices with high power consumption, such as electric power tools, where a mains transformer would not be used because of its weight.

### DRAWING

Further advantages will become apparent from the ensuing description of the drawing. In the drawing, exemplary embodiments of the invention are shown. The drawing, description and claims include numerous characteristics in combination. One skilled in the art will expediently consider the characteristics individually as well and put them together to make useful further combinations.

Shown are:

FIG. 1, a schematically shown battery-operated power drill;

FIG. 2, a battery;

FIG. 3, a power supply unit;

FIG. 4, an enlarged view of contact recesses, seen in the direction information connection of FIG. 3;

FIG. 5, an enlarged detail of contact pins of the battery-operated power drill of FIG. 1;

FIG. 6, a battery charger of the invention; and

FIG. 7, a case for the battery-operated power drill of FIG. 1, with a battery charger that is an alternative to what is shown in FIG. 6.

### DESCRIPTION OF THE EXEMPLARY EMBODIMENTS

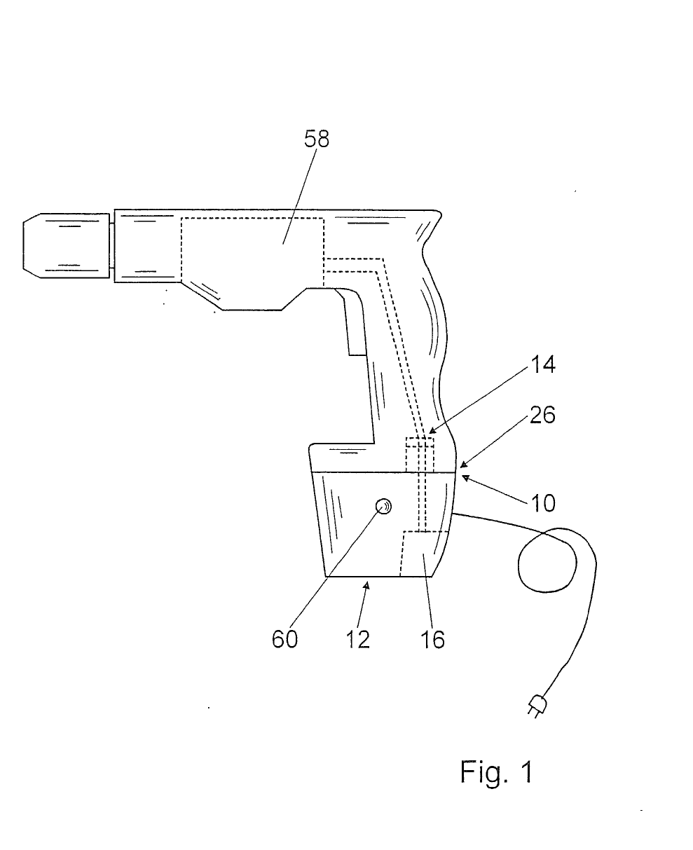

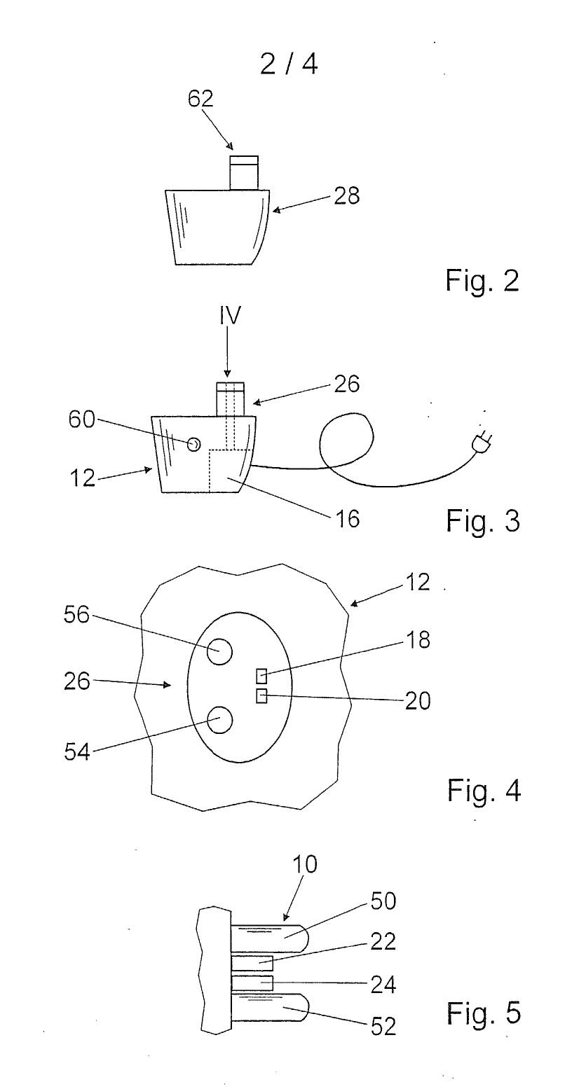

FIG. 1 shows a battery-operated power drill with a connection point 10, to which both a power supply unit 12 and a battery 28 can be coupled (FIGS. 2 and 3). The power supply unit 12 and the battery 28 have suitable housings. The power supply unit 12 is embodied as a switching-type power supply unit, which is operated at a frequency greater than 100 kHz and can therefore be made especially lightweight.

According to the invention, via an information connection 14, information from the connection point 10 of the battery-operated power drill can be forwarded to the power supply unit 12 and utilized in a regulating unit 16 in the power supply unit 12. If the power supply unit 12 is coupled by its connection point 26 to the connection point 10 of the battery-operated power drill, then four contact pins 22, 24, 50, 52 (FIG. 5), secured to the connection point 10 of the battery-operated power drill, are introduced into four corresponding contact recesses 18, 20, 54, 56 of the connection point 26 of the power supply unit (FIG. 4). Once the contact pins 22, 24, 50, 52 have been introduced into the contact recesses 18, 20, 54, 56, the power supply unit 12 is secured via a detent connection, not shown in further detail, on the battery-operated power drill.

Via the contact recesses 54, 56 and the contact pins 50, 52, the battery-operated power drill is supplied with current. Via the contact pin 22 and the contact recess 18, set-point values are forwarded from an electric motor 58 of the battery-operated power drill to the regulating unit 16 of the power supply unit 12. Via the set-point values, the voltage and current intensity with which the electric motor 58 should advantageously be operated are predetermined. The regulating unit 16 of the power supply unit 12 then regulates the voltage and current intensity, output at the connection point 26, to the predetermined set-point values.

Via the contact pin 24 and the contact recess 20, temperature parameters of the electric motor 58 are forwarded to the regulating unit 16. If the temperature parameter increases beyond a defined value as a consequence of an especially high load on the battery-operated power drill, the power output to the battery-operated power drill by the power supply unit 12 is reduced, until such time as the temperature parameter drops back below this value again. An overload on the battery-operated power drill is securely averted. Via a monitor light 60, the reduced energy supply and the attendant reduced power of the battery-operated power drill are indicated to a user.

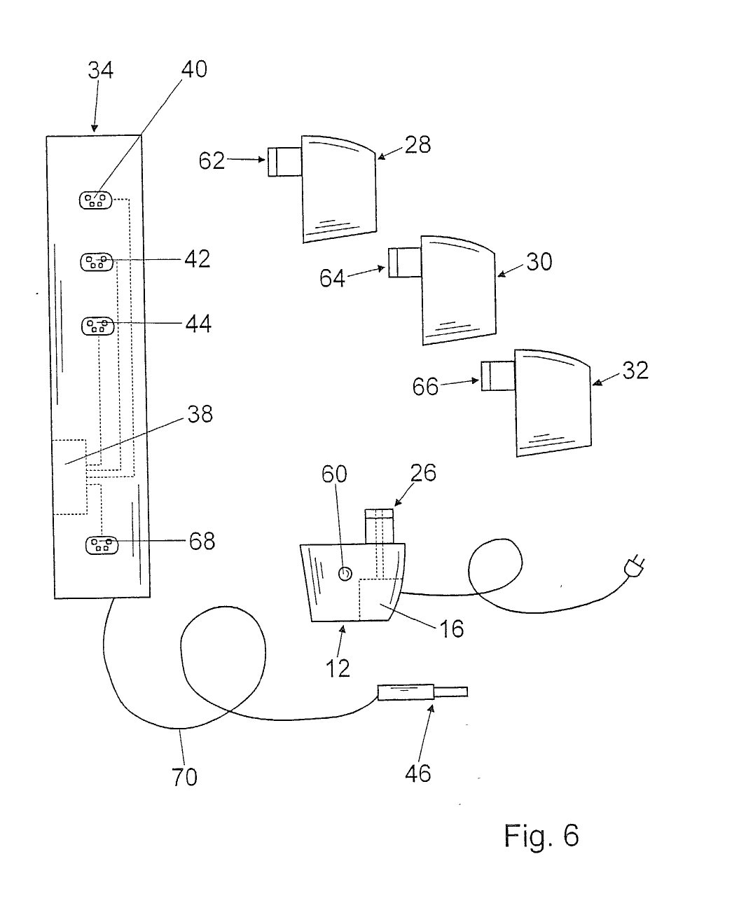

The power supply unit 12, with its connection point 26, can be connected via an adapter 34 to connection points 62, 64, 66 of three batteries 28, 30, 32 simultaneously, specifically for the sake of charging the batteries 28, 30, 32. A corresponding battery charger with the power supply unit 12 and the adapter 34 for charging the batteries 28, 30, 32 is shown in FIG. 6. The connection points 62, 64, 66 of the batteries 28, 30, 32 each have four contact recesses, not identified by reference numeral, that correspond to those of the connection point 26 of the power supply unit 12.

For charging, the batteries 28, 30, 32 are plugged by their connection points 62, 64, 66 into three connection points 40, 42, 44 of the adapter 34. The connection points 40, 42, 44 of the adapter 34 have four contact pins, not identified by reference numeral, which correspond to those of the connection point 10 of the battery-operated power drill. The power supply unit 12 is plugged by its connection point 26 into a connection point 68 of the adapter 34, which like the connection point 10 of the battery-operated power drill has four contact pins.

Information about the charge state of the batteries 28, 30, 32 at the time is forwarded via an information connection from the connection points 62, 64, 66 of the batteries 28, 30, 32 to a regulating unit 38, integrated into the adapter 34, via the connection points 40, 42, 44. Depending on the individual charge states of the batteries 28, 30, 32, the regulating unit 38 regulates the charging current supplied to each one. For instance, if one battery has lost most of its charge and another battery retains most of its charge, then via the regulating unit 38, a high charging current is delivered to the battery that has largely lost its charge, and a low charging current is delivered to the battery that still has most of its charge. Moreover, via an information connection to the power supply unit 12, the regulating unit 38 regulates the total charging current required for this purpose.

According to the invention, the adapter 34 has a power cord 70 with a plug 46, which can be inserted into a recess, not shown in further detail, of a cigarette lighter of a motor vehicle; by way of this plug, the adapter 34 can be supplied with current for charging the batteries 28, 30, 32.

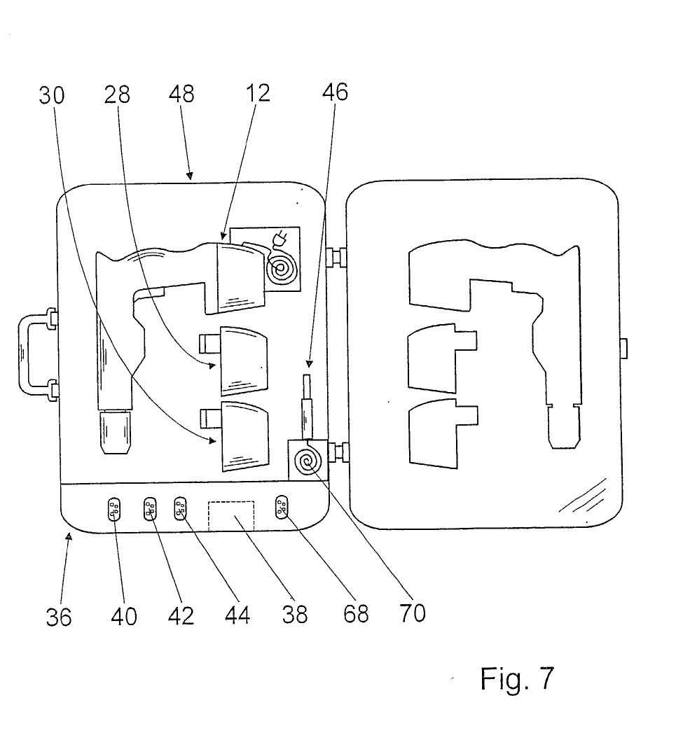

In FIG. 7, an alternative adapter 36 to the exemplary embodiment of FIG. 6 is shown; its housing is embodied integrally with a case 48 of the battery-operated power drill. Components that remain essentially the same are all identified by the same reference numerals. Moreover, for functions and characteristics that remain the same, reference may be made to the description of FIG. 6.

List of Reference Numerals

| | |
|---|---|
| 10 | Connection point |
| 12 | Power supply unit |
| 14 | Information connection |
| 16 | Unit |
| 18 | Contact point |
| 20 | Connection point |
| 22 | Power supply unit |
| 24 | Information connection |
| 26 | Connection point |
| 28 | Battery |
| 30 | Battery |
| 32 | Battery |
| 34 | Adapter |
| 36 | Adapter |
| 38 | Regulating unit |
| 40 | Connection points |
| 42 | Connection points |
| 44 | Connection points |
| 46 | Connection point |
| 48 | Case |
| 50 | Contact pin |
| 52 | Contact pin |
| 54 | Contact recess |
| 56 | Contact recess |
| 58 | Electric motor |
| 60 | Monitor light |
| 62 | Connection point |
| 64 | Connection point |
| 66 | Connection point |
| 68 | Connection point |
| 70 | Power cord |

1. An electrical device, in particular a power tool, having a connection point (10) to which at least one power supply unit (12) can be coupled, characterized in that via an information connection (14) at least from the connection point (10), information can be forward to the power supply unit (12), and the information can be utilized in a unit (16) in the power supply unit (12).

2. The electrical device of claim 1, characterized in that via the information connection (14), the voltage and/or current intensity picked up from the power supply unit (12) can be adjusted.

3. The electrical device of claim 1 or 2,
characterized in that via the information connection (14), information for avoiding an overload can be forwarded.

4. The electrical device of claim 3, characterized in that via the information connection (14), temperature parameters can be forwarded.

5. The electrical device of one of the foregoing claims, characterized in that the connection point (10) and the power supply unit (12) each have at least one contact point (18, 20, 22, 24), which upon coupling of the power supply unit (12) are mechanically connectable and by way of which the information can be forwarded.

6. A power supply unit, having at least one connection point (26) for coupling to an electrical device, in particular to a power tool, characterized in that via an information connection (14) at least via the connection point (26), information can be forward to the power supply unit (12), and the information can be utilized in a unit (16).

7. The power supply unit of claim 6, characterized in that via the information connection (14), the voltage and/or current intensity picked up via the connection point (26) can be adjusted.

8. The power supply unit of claim 6 or 7,
characterized in that via the information connection (14), information for avoiding an overload of the electrical device can be forwarded.

9. The power supply unit of one of claims 6-8,
characterized in that a battery (28, 30, 32) for charging can be operatively connected to the connection point (26) or to a second connection point.

10. A battery charger of an electrical device, in particular of a power tool, which can be selectively supplied with current via a coupleable battery (28, 30, 32) or via a coupleable power supply unit (12), characterized in that the power supply unit (12) and the battery (28, 30, 32) are connectable via an adapter (34, 36), and from the adapter (34, 36) via an information connection, information can be forwarded to the power supply unit (12), and the information can be utilized in a unit (16) in the power supply unit (12).

11. The battery charger of claim 10, characterized in that a regulating unit (38) is integrated with the adapter (34, 36).

12. The battery charger of claim 10 or 11,
characterized in that the adapter (34, 36) has at least two connection points (40, 42, 44) for simultaneously charging two batteries (28, 30, 32).

13. The battery charger of one of claims 10-12,
characterized in that the adapter (34, 36) has one connection point (46), via which the adapter (34, 36) can be supplied with current via a cigarette lighter of a motor vehicle.

14. The battery charger of one of claims 10-13,
characterized in that the adaptor (36) is integrated in a case (48) of the electrical device.

15. The battery charger of claim 14, characterized in that the adapter (36) is embodied at least partly integrally with the case (48) of the electrical device.
